(19) United States
(12) Patent Application Publication
(10) Pub. No.: US 2005/0017617 A1
(43) Pub. Date: Jan. 27, 2005

(54) Built-in refrigerator with a translucent door

(75) Inventor: Christoph Becke, Grosskarolinenfeld (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/926,416

(22) Filed: Aug. 25, 2004

Related U.S. Application Data
(63) Continuation of application No. PCT/EP03/01086, filed on Feb. 4, 2003.

(30) Foreign Application Priority Data
Feb. 25, 2002 (DE) 102 07 990.0

(51) Int. Cl. B67D 5/62; A47B 96/04

(52) U.S. Cl. 312/404; 312/401

(57) ABSTRACT

A built-in refrigerator contains a housing door that is transparent in at least one portion of its surface area. The housing door is not necessarily lined with a decorative door. The refrigerator makes it possible for goods that need cooled or temperature-controlled storage to be displayed in an esthetically pleasing form that can easily be adapted to the configuration and decor of a room in which the appliance is to be set up.

### CROSS-REFERENCE TO RELATED APPLICATION

This application is a continuation, under 35 U.S.C. § 120, of copending international application No. PCT/EP03/01086, filed Feb. 4, 2003, which designated the United States; this application also claims the priority, under 35 U.S.C. § 119, of German patent application No. 102 07 990.0, filed Feb. 25, 2002; the prior applications are herewith incorporated by reference in their entirety.

### BACKGROUND OF THE INVENTION

### FIELD OF THE INVENTION

The present invention relates to a refrigerator having a heat-insulating housing and at least one housing door for closing a storage space formed in the interior of the housing. The door is translucent at least over part of its surface area.

Such refrigerators are used, in particular, in self-service grocery stores, where they are utilized for storing chilled food and allow customers to view the goods contained within, without the door of the refrigerator having to be opened for this purpose and undesired heat penetrating into the storage space.

These appliances are configured as standing appliances, and their outer configuration is generally unremarkable and not particularly variable. As a result, they do not lend themselves well to being used in surroundings in which importance is placed on a pleasing appearance, for example in those areas of catering establishments which are accessible to the guests.

### SUMMARY OF THE INVENTION

It is accordingly an object of the invention to provide a built-in refrigerator with a translucent door which overcomes the above-mentioned disadvantages of the prior art devices of this general type, which makes it possible for goods which need cooled or temperature-controlled storage to be displayed in an esthetically pleasing form which can easily be adapted to the configuration and decor of a room in which the appliance is to be set up.

With the foregoing and other objects in view there is provided, in accordance with the invention, a refrigerator. The refrigerator contains a built-in appliance which has a heat-insulating housing defining an interior with a storage space and at least one housing door for closing the storage space, formed in the interior of the housing. The housing door has a translucent part being translucent and extending over at least part of a surface area of the housing door.

The object is achieved in that the refrigerator is configured as a built-in appliance.

Conventional built-in refrigerators generally have a door with a front side that is not particularly esthetically pleasing, is made of an inexpensive material and is provided in order to be concealed behind a unit door rather than to be viewed directly by a user. The unit door and refrigerator door here are, for example, each suspended on a dedicated hinge and can be displaced in relation to one another on rails when opened.

Turning away from the opinion, which has prevailed among experts up until now, that the doors of built-in appliances have to be adapted, in terms of appearance and/or design, to adjacent facing arrangements of a row of kitchen units, e.g. by unit facing configurations, a built-in refrigerator with a unique door of translucent construction is now proposed. The door of the built-in appliance thus stands out, in a technically enriching manner, from the adjacent facing configurations of a row of kitchen units.

Such a unit door is dispensed with in the case of a preferred configuration of the refrigerator according to the invention.

Instead, the housing door of the refrigerator itself may be produced from high-grade, esthetically pleasing materials.

If, in the case of another configuration of the refrigerator according to the invention, a unit door is indeed provided, then, in particular if it is cut away in a region corresponding to the translucent surface area of the housing door, it may be more lightweight than a conventional unit door for a built-in refrigerator, with the result that it may be expedient to install the unit door in a non-displaceable manner in front of the housing door.

The translucent part of the housing-door surface area is preferably transparent, in order for it to be possible to see all the details of articles stored behind it. It is also conceivable, however, to provide the housing-door surface area with a more or less intense degree of opaqueness, with the result that, although it is possible to see from the outside that there is an article present in the storage space, this article cannot be seen specifically.

The translucent part of the housing door is expediently formed by an insulating glass panel, i.e. an arrangement of two or more glass panels that are separated in each case by insulating gas layers. The glass of the panels may be, in particular, mineral glass or a translucent plastic.

The refrigerator according to the invention is preferably configured as a storage cabinet for bottles, in particular for wine bottles.

Other features which are considered as characteristic for the invention are set forth in the appended claims.

Although the invention is illustrated and described herein as embodied in a built-in refrigerator with a translucent door, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a refrigerator according to the invention; and

FIGS. 2 and 3 are diagrammatic, sectional partial sectional views through an appliance door according to two different configurations of the invention.

### DESCRIPTION OF THE PREFERRED EMBODIMENTS

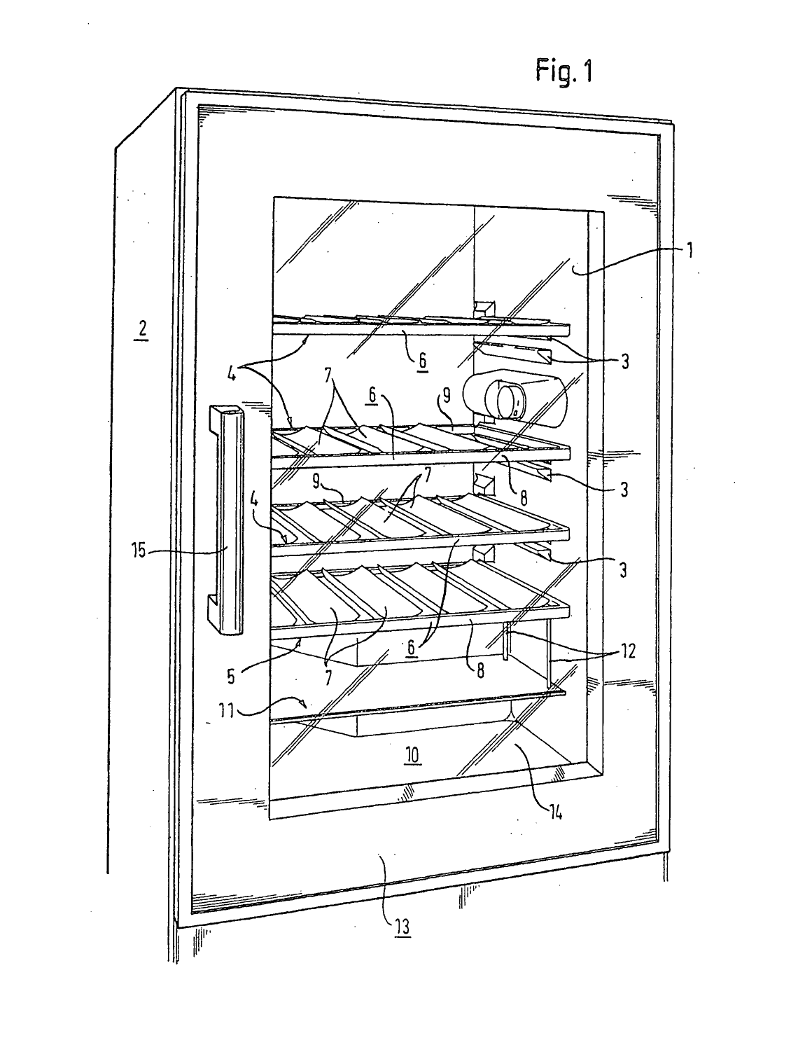

Referring now to the figures of the drawing in detail and first, particularly, to FIG. 1 thereof, there is shown a refrigerator that has a housing which is constructed in a manner known per se from an inner container 1, which is thermoformed from plastic and bounds the storage compartment in the interior of the appliance, and an outer wall 2, which is joined together, for example, from metal sheets or may likewise be thermoformed from a plastic panel and, together with the inner container 1, bounds an interspace with thermally insulating foam filling. Cross pieces 3 that are integrally formed on the sides of the inner container 1 bear shelves 4, 5. The shelves 4, 5 are each constructed from a quadrilateral frame 6 which is made of die cast aluminum and on which are fitted a plurality of cylinder-segment-type trays 7 which extend in the depth wise direction of the inner container 1. The trays 7 are each fastened on a front and a rear strut 8, 9, respectively, of the frame 6 and are not connected to one another. The trays 7 are formed of a frosted, translucent mineral glass or plastic.

A compressor of the refrigerating machine of the refrigerator is accommodated, in a manner known per se, behind a hollow 10 of the inner container 1, the hollow 10 reaching into the storage compartment. It is not possible to install a rectangular shelf level with the hollow 10; in order to optimize the use of the space available here, a shelf 11 with a continuous panel is fastened on the frame 6 of the shelf 5 in a manner in which it is suspended via rods 12. The shelf 11 and a floor surface of the inner container 1 located therebeneath can be utilized, in the region in front of the hollow 10, for example for storing smaller bottles than those of dimensions appropriate for the trays 7.

The above-described storage compartment is visible through a closed housing door 13. The housing door 13 is formed by an insulating glass panel 14 that fills a large part of the surface area of the housing door 13 and is surrounded in a frame that is made up of extruded aluminum profiles.

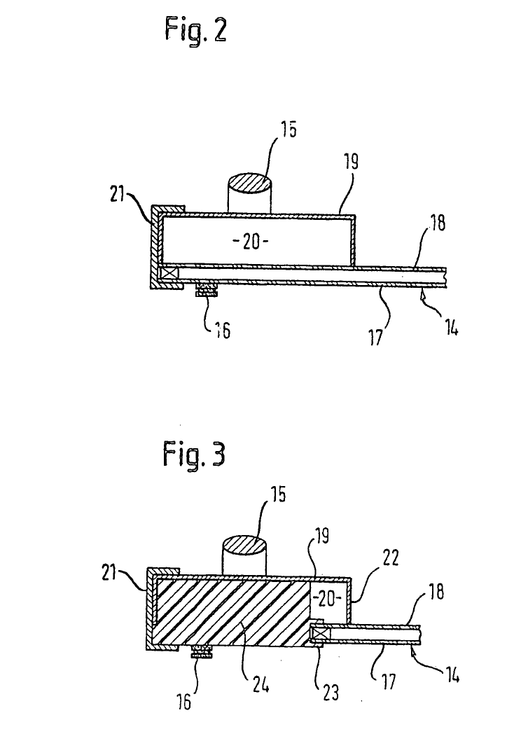

Examples of a possible cross-sectional structure of the housing door 13 are shown in FIGS. 2 and 3, which each show a partial section through the housing door 13 level with the door handle 15.

In the case of the configuration of FIG. 2, the insulating glass panel 14 extends over the entire surface of the housing door 13 and a magnetic seal 16 for sealing a gap between the inner container 1 and housing door 13 is fastened on an inner panel 17 of the two panels 17, 18 which form the insulating glass panel 14. Fastened on an outer panel 18, in the peripheral region of the latter, is an aluminum profile 19 which has a C-shaped cross section, bears the door handle 15, e.g. by screw connection, and can have its hollow interior 20 filled with insulating foam material. An outer covering of the housing door 13 is formed by a second aluminum profile 21 of C-shaped cross section, of which one of the two parallel legs butts against the outside of the profile 19 and the other butts against the inner panel 17.

In the case of the housing door according to FIG. 3, the two aluminum profiles 19, 21 are identical to those of FIG. 2 and thus need not be described again. The insulating glass panel 14 is smaller than that of FIG. 2; rather than reaching the outer profile, it terminates at a small distance from an inner leg 22 of the profile 19. The inner panel 17 butts against a tongue 23 of a plastic profile 24, which also fills part of an interior 20 of the aluminum profile 19 and is fixed to the profile 19. It is also possible for the plastic profile 24 to be provided with insulating-foam-filled cavities, which are not illustrated in the cross section.

In the case of a modification of the cross section of FIG. 2 which has not been depicted, the aluminum profile 19 is dispensed with, and the outer aluminum profile 21 is dimensioned such that its legs each butt against the outside of the panels 17 and 18. In this case, the door handle cannot be screw-connected; adhesive bonding to the outer panel 18, however, is readily possible.

It goes without saying that, in particular if the insulating glass panel 14 extends over the entire surface area of the housing door 13, the two profiles 19, 21 can also easily be replaced by wooden profiles which have their outer configuration adapted, in the manner which is customary for built-in appliances, to the configuration of the built-in appliance of adjacent unit facing arrangements. Since these profiles only cover over a peripheral region of the insulating glass panel 14, they are considerably more lightweight than a continuous unit-door leaf of the same size. For this reason, and also because the inside of the housing door 13 is not fitted, according to the invention, with article supports, the loading of which could increase the weight of the door, these wooden profiles can easily be born by the door-suspension device of the refrigerator and thus do not require any dedicated suspension device. It is thus possible for the wooden profiles to form a frame-like unit door.

1. A refrigerator, comprising:
a built-in appliance, containing:
a heat-insulating housing defining an interior having a storage space; and
at least one housing door for closing said storage space, formed in said interior of said housing, said housing door having a translucent part being translucent and extending over at least part of a surface area of said housing door.

2. The refrigerator according to claim 1, wherein the refrigerator does not have a unit door positioned in front of said housing door.

3. The refrigerator according to claim 1, further comprising a unit door having a given surface area and positioned in front of said housing door, said unit door being translucent or cut away over part of said given surface area.

4. The refrigerator according to claim 1, wherein said translucent part being translucent over said surface area of said housing door is transparent.

5. The refrigerator according to claim 1, wherein said translucent part is an insulating glass panel.

6. The refrigerator according to claim 1, wherein said built-in appliance is a storage cabinet for bottles.
